(19) United States
(12) Patent Application Publication
(10) Pub. No.: US 2025/0291814 A1
(43) Pub. Date: Sep. 18, 2025

(54) UNIFIED DATA REPOSITORY (UDR) SLICING UNDER LIVE TRAFFIC AND SUPPORT FOR 5G CALL FLOWS

(71) Applicant: T-MOBILE INNOVATIONS LLC, Overland Park, KS (US)

(72) Inventors: Anuj Sharma, Broadlands, VA (US); Kumar Pushkar, Herndon, VA (US)

(21) Appl. No.: 18/608,494

(22) Filed: Mar. 18, 2024

(51) Int. Cl. G06F 16/27; H04W 8/20; H04W 12/06; H04W 76/10

(52) U.S. Cl. CPC G06F 16/278; H04W 8/20; H04W 12/06; H04W 76/10

(57) ABSTRACT

Systems, methods, and devices are disclosed herein for slicing data repositories, such as the Unified Data Repository (UDR) in a 5G core network under live traffic conditions. To support UDR slicing, several new network elements are introduced including the subscriber location function (SLF), the identity lookup, and the provisioning orchestrator. In an access call flow the SLF intercepts requests for subscriber information stored in the UDR, obtains information about which UDR segment hosts the requested subscriber data from the identity lookup, retrieves the subscriber information from the identified UDR segment, and responds to the request. In provisioning call flows, the provisioning orchestrator also leverages the identity lookup to locate the relevant subscriber information. A migration tool is also disclosed for the relocating of subscriber information from a first UDR to a second UDR under live traffic conditions.

### TECHNICAL FIELD

Various embodiments of the present technology relate to wireless communication networks and in particular to subscriber data access and management.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices include phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices. Exemplary network functions include Access and Mobility Management Function (AMF), Policy Control Function (PCF), Unified Data Management (UDM), and Unified Data Repository (UDR).

A UDR is a Fifth Generation Core (5GC) network entity that stores network and subscriber data. The subscriber data is organized into subscriber profiles that each correspond to a wireless user device subscribed for service on the network. The subscriber profiles store data like service attributes, network policy authorizations, mobility policies, and the like. The subscriber profiles are associated with the user devices based on device Identifiers (IDs) like International Mobile Subscriber Identity (IMSI). When another network function (e.g., UDM) needs to retrieve subscriber data to serve a user device, the network function accesses the subscriber profile stored by the UDR that is associated with that user device. The network function then serves the user device based on the retrieved subscriber data. Traditionally, the UDR is a monolithic database that stores the entire subscription base. However, such an approach places heavy reliance on a single data repository potentially creating a single point of failure. Additionally, the increase in Fifth Generation (5G) subscribers in wireless communication networks stresses the storage capacity of the UDR.

It is with respect to this general technical environment that aspects of the present technology disclosed herein have been contemplated. Furthermore, although a general environment has been discussed, it should be understood that the examples described herein should not be limited to the general environment identified in the background.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the present technology generally relate to the storage of subscriber information in wireless communication networks. More specifically, the technology disclosed herein includes the segmentation of the unified data repository (UDR) under live traffic conditions and support for the segmented UDR infrastructure during operational call flows. In a first embodiment, a method of operating a wireless communication network includes: receiving a request for subscriber information associated with a subscriber stored in a database segment of a plurality of database segments, wherein each database segment of the plurality of database segments stores a different portion of subscriber profiles stored across the plurality of database segments; in response to the request, obtaining information indicating that the subscriber information associated with the subscriber is stored in the database segment; upon obtaining the information indicating that the subscriber information associated with the subscriber is stored in the database segment, retrieving the subscriber information associated with the subscriber from the database segment; and responding to the request with the subscriber information associated with the subscriber.

In some embodiments, the plurality of database segments make up a UDR associated with the wireless communication network. The request, in some examples, is from an authentication entity of the wireless communication network and the authentication entity sent the request for the subscriber information associated with the subscriber in response to receiving an authentication request associated with the subscriber. Responding to the request with the subscriber information associated with the subscriber includes, in some embodiments, responding to the request with one or more authentication vectors generated based on the subscriber information associated with the subscriber stored in the database segment. The request may be part of an authentication call flow to verify that the subscriber is authorized to access one or more services of the wireless communication network. The request may also be part of a session establishment call flow to establish a new session for the subscriber for accessing one or more services of the wireless communication network. The subscriber information, in some examples, includes at least one of a quality of service parameter, a service entitlement, subscriber identity data, subscriber location information, or service plan details. The wireless communication network, in some embodiments, is a Fifth Generation (5G) cellular communication network.

In another embodiment of the present technology, a wireless communication network includes: a UDR comprising two or more database segments, wherein each database segment of the two or more database segments stores a different portion of subscriber profiles in the UDR; an identity database configured to store information indicating which database segment of the two or more database segments stores subscriber information for each subscriber profile of the subscriber profiles in the UDR; and a subscriber location function component. In said embodiment, the subscriber location component is configured to: receive a request for subscriber information associated with a subscriber stored in a database segment of the two or more database segments; in response to the request, obtain information from the identity database indicating that the subscriber information associated with the subscriber is stored in an identified database segment of the two or more database segments; upon obtaining the information indicating that the subscriber information associated with the subscriber is stored in the identified database segment, retrieve the subscriber information associated with the identified database segment; and respond to the request with the subscriber information associated with the subscriber.

In yet another embodiment of the technology, one or more non-transitory computer-readable storage media have program instructions stored thereon that, when executed by a computing system, direct the computing system to perform operations including: receiving a request for subscriber information associated with a subscriber stored in a database segment of a plurality of database segments, wherein each database segment of the plurality of database segments stores a different portion of subscriber profiles stored across the plurality of database segments; in response to the request, obtaining information indicating that the subscriber information associated with the subscriber is stored in the database segment; upon obtaining the information indicating that the subscriber information associated with the subscriber is stored in the database segment, retrieving the subscriber information associated with the subscriber from the database segment; and responding to the request with the subscriber information associated with the subscriber.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an existing communication network to in accordance with pre-existing communications technology;

FIG. 2 illustrates a Fifth Generation (5G) wireless communication network in accordance with some embodiments of the present technology;

FIG. 3 is a flowchart illustrating a series of steps performed in a 5G wireless communication network in accordance with some embodiments of the present technology;

FIG. 4 is a flowchart illustrating a series of steps performed in a 5G wireless communication network in accordance with some embodiments of the present technology;

FIG. 5 illustrates a 5G wireless communication network according to one or more embodiments of the present technology;

FIG. 6 illustrates network functions in the 5G wireless communication network according to one or more embodiments of the present technology;

FIG. 7 illustrates a Network Function Virtualization Infrastructure (NFVI) in the 5G wireless communication network according to one or more embodiments of the present technology; and

FIG. 8 illustrates a computing system suitable for implementing the various operational environments, architectures, processes, scenarios, and sequences discussed below with respect to the other Figures.

### DETAILED DESCRIPTION

Systems, methods, and devices are disclosed herein for slicing data repositories, such as the Unified Data Repository (UDR) in a 5G core network under live traffic conditions. The UDR is a database in the 5G network core that stores network and subscriber data for purposes of network authentication and registration in 5G network call flows. The UDR is accessed by other entities in the network core to retrieve data to serve a user, in which case the UDR may provide information such as a determined data rate, the quality of service, latency, authorized services, and the like. Traditionally, the UDR is a monolithic database that stores the entire subscription base. However, such an approach places unnecessary reliance on a single data repository potentially creating a single point of failure.

Thus, according to the present disclosure, a subscription data repository (e.g., the UDR) is sliced into at least two separate database segments. Slicing, as described herein, refers to dividing or portioning a dataset into smaller, more manageable segments based on specific criteria or attributes. Slicing helps organize data in a structured manner, making it easier to locate and access information. Thus, in accordance with the present disclosure, the UDR is sliced into two or more segments based on, for example, core network functions and/or service types. For example, a first segment may comprise a group of network functions with low-latency capabilities while a second segment may comprise a group of network functions with standard capabilities.

An aspect of the database slicing as described herein is that the slicing occurs under live traffic conditions. Thus, systems and methods are disclosed that enable the database to be sliced under the live conditions as well as support requests, accesses, and provisioning once the slicing has begun and once it is completed.

Thus, to perform and support UDR slicing as disclosed herein, several new network elements are introduced. The first new element is the subscriber location function (SLF). The SLF is responsible for routing traffic to the correct UDR segment. Once migrating profiles from the single UDR to additional slices has begun, the SLF, upon receiving a request, identifies the database segment that is hosting the subscription being authenticated, allowing it to latch on to the network. The SLF interacts with existing routing functions to determine which database segment a subscriber belongs to. When the SLF receives a request, it queries the second new network element, the Identity Lookup, for information regarding which segment a subscriber belongs to. The Identity Lookup is a database that stores information about which database segment subscriber information resides in.

The third new component implemented in the core network to support database repository slicing is the provisioning orchestrator (PO). The provisioning orchestrater is a centralized provisioning system that interfaces with the customer relationship management (CRM) client server and executes subscriber provisioning flows across database segments. Subscriber profiles, plans, and assigned services are thus administered by the provisioning orchestrator. In some embodiments of the present technology, another new network element, the migration function, is implemented for temporary support in slicing the database. The migration function performs the actual migration of subscriber profiles from one database slice to another. Once the slicing is completed, however, the migration function is no longer of use.

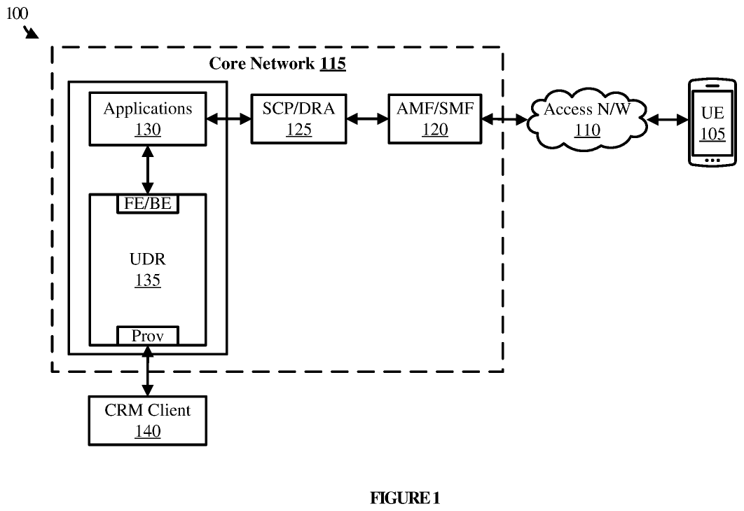

FIG. 1 illustrates communication network 100, which is representative of existing 5G network infrastructure in which the entire subscription database is hosted in a single UDR. Communication network 100 delivers services like voice calling, machine communications, internet-access, media-streaming, or some other wireless/wireline communications product to user devices. Communication network 100 includes user equipment (UE) 105, access network 110, core network 115, and CRM client 140. Core network 115 includes Access and Mobility Management Function/Session Management Function (AMF/SMF) 120, Service Control Point/Diameter Routing Agent (SCP/DRA) 125, applications 130, and UDR 135. In other examples, communication network 100 may include additional or different elements than those illustrated in FIG. 1.

In the present example, UDR 135 stores all subscriber profiles for users on communication network 100. The subscriber profiles stored in UDR 135 include service attributes that define the level of service to be provided to users. For example, the subscriber profile for UE 105 may include data indicating the Quality-of-Service (QoS), bitrate, latency, mobility, policies, network policy authorization, and/or other metrics defining the level of service associated with the user device. Network entities within communication network 100 read the service attributes stored in the subscriber profiles in UDR 135 to provide wireless data services to users over access network 110.

UE 105 is representative of a wireless/wireline user device. Exemplary user devices include phones, smartphones, computers, vehicles, drones, robots, sensors, and/or other devices with wireless communication capabilities. Access network 110 exchanges wireless signals with UE 105 over radio frequency bands. The radio frequency bands use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). Access network 110 is connected to core network 115 over backhaul data links. Access network 110 exchanges network signaling and user data with other network elements in communication network 100.

Access network 110 may include wireless access nodes, internet backbone providers, edge computing systems, or other types of wireless/wireline access systems to provide wireless links to UE 105, backhaul links to core network 115, and the edge computing services between the user devices and core network 115. The wireless access nodes of access network 110 may include Fifth Generation (5G) RANs, LTE RANs, gNodeBs, eNodeBs, NB-IoT access nodes, LP-WAN base stations, wireless relays, WIFI hotspots, Bluetooth access nodes, and/or other types of wireless or wireline network transceivers. The access nodes may include Radio Units (RUs), Distributed Units (DUs), and/or Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to core network 115. The CUs handle higher wireless network layers like the Radio Resource Control (RRC), Service Data Adaption Protocol (SDAP), and Packet Data Convergence Protocol (PDCP). The CUs are coupled to network functions in core network 115.

Core network 115 is representative of computing systems that provide wireless data services to user devices (e.g., user device 105) over access network 110. Exemplary computing systems comprise data centers, server farms, Network Function Virtualization Infrastructure (NFVI), cloud computing networks, hybrid cloud networks, and the like. The computing systems of core network 115 store and execute the network functions to provide wireless data services to user device 105 over access network 110. The computing systems of core network 115 typically store and execute network functions to form a control plane (not illustrated) and a user plane (not illustrated) to serve UE 105. The control plane may include network functions such AMF/SMF 120, a Policy Control Function (PCF), Unified Data Management (UDM), and a Home Subscriber Server (HSS). The user plane may include network functions like User Plane Function (UPF). Core network 115 may comprise a Fifth Generation Core (5GC) architecture, an Evolved Packet Core (EPC) architecture, or the like.

AMF/SMF 120 is representative of core network functions that handle the connectivity, mobility, and session management in a 5G network. The Access and Mobility Management Function (AMF) is responsible for access and mobility management including the initial registration of devices, authentication, tracking area management, and ensuring that users remain connected as they move through the network. The AMF serves as the point of contact for a user device (e.g., UE 105) when it tries to connect to the 5G network (e.g., communication network 100). The AMF manages the establishment, maintenance, and termination of the connection between UE 105 and core network 115. The Session Management Function (SMF) is responsible for session management including establishing, modifying, and releasing sessions (which include one or more data flows). The SMF also selects and manages the user plane functions, handles aspects of IP address allocation, and maintains the rules for how data should be routed and reported. The SMF ensures that data can be successfully transmitted between UE 105 and the internet or other network services.

During an access call flow (southbound), the AMF accesses UDR 135 to retrieve and update access and mobility subscription information for a user. For example, when a user's device (i.e., UE 105) tries to connect to the network, the AMF queries UDR 135 via the SCP to authenticate the user and obtain their profile, which includes information such as the user's identity, security credentials, and access authorization. The SMF connects to UDR 135 through the application site (i.e., applications 130) to retrieve session management subscription information. Before establishing a session, the SMF consults UDR 135 to get details such as the user's service profile, QoS rules, and any data routing configurations. This information allows the SMF to correctly establish and manage the network session according to the user's subscription and policy requirements.

Alternatively, provisioning call flows (northbound) go through CRM client 140. In accordance with the single-UDR example of FIG. 1, Customer Relationship Management (CRM) client 140 is responsible for provisioning. CRM client 140 indirectly accesses UDR 135 through the provisioning gateway. CRM client 140 is responsible for handling new customer onboarding, creating and loading profiles, subscription changes, and managing customer data. In some embodiments, CRM client 140 does not directly interact with UDR 135 at the protocol level, but plays an important role in managing subscription data that eventually gets updated or added to the UDR. In some examples, when a customer requests to add a new service or modify an existing subscription, the subscription information may be updated in CRM client 140. This could involve adding new services, changing plans, updating personal information, and the like. Changes made in CRM client 140 may then be passed to a provisioning system or service orchestration layer, which is responsible for implementing the service changes across the various network systems and databases, including UDR 135.

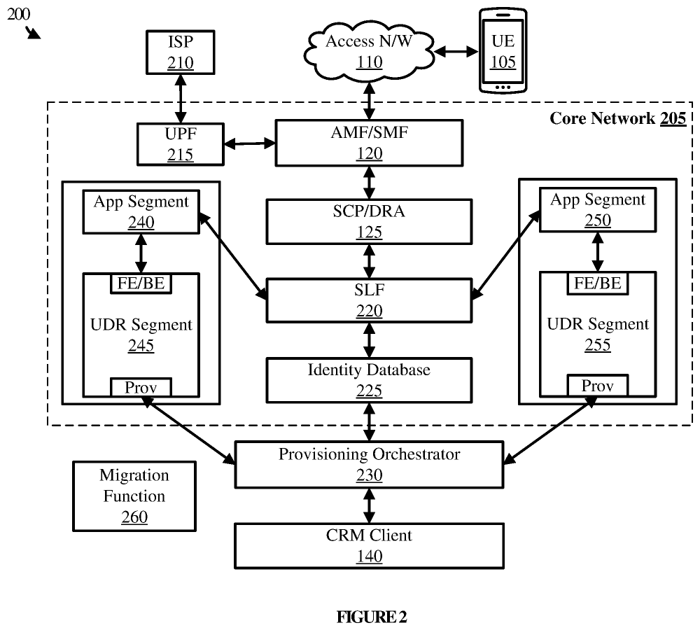

FIG. 2 illustrates communication network 200, which is representative of the 5G network infrastructure disclosed herein in which the entire subscription database is no longer hosted in a single UDR, but across multiple UDRs. Communication network 200 may deliver the same services as communication network 100, but with multiple UDR segments. Communication network 200 includes core network 205, UE 105, access network 110, ISP 210, CRM client 140, provisioning orchestrator 230, and migration function 260. Core network 205 includes UPF 215, AMF/SMF 120, SCP/DRA 125, SLF 220, identity database 225, application segment 240, UDR segment 245, application segment 250, and UDR segment 255. In other examples, communication network 200 may include additional or different elements than those illustrated in FIG. 2.

In the example of FIG. 2, UDR segment 245 and UDR segment 255 together store all subscriber profiles for users on communication network 200. The subscriber profiles stored in UDR segment 245 and UDR segment 255, similar to UDR 135 from FIG. 1, include service attributes that define the level of service to be provided to users. For example, the subscriber profile for UE 105 still includes data indicating the Quality-of-Service (QoS), bitrate, latency, mobility, policies, network policy authorization, and/or other metrics defining the level of service associated with the user device. The subscriber profile for UE 105, however, is stored on only one UDR segment. The subscriber profile for UE 105 may therefore be stored in UDR segment 245 in the present example. Network entities within communication network 200 may therefore read the service attributes associated with UE 105 stored in UDR segment 245 to provide wireless data services to users over access network 110.

As previously described, communication network 200 differs from communication network 100 at least in part because subscriber profiles are divided across two distinct UDR segments. To support this new infrastructure, three new network elements are introduced-SLF 220, identity database 225, and provisioning orchestrator 230. SLF 220 is representative of the subscriber location function, which helps identify the database segment that is hosting the subscription being authenticated to allow latching onto the network. SLF 220 is used by the routing functions (e.g., SCP/DRA 125) that must determine which database segment a user belongs to. SLF 220 interacts with SCP/DRA 125 to assist with routing to the appropriate UDR segment. Identity database 225 stores information indicating which UDR segment the subscriber information resides in. Thus, when SLF 220 receives a call from SCP/DRA 125, SLF 220 queries identity database 225 to identify which UDR segment stores the subscription information for the requesting entity (e.g., UE 105) and then routes the call to the appropriate segment.

Thus, in an access call flow (southbound) in accordance with the example of FIG. 2, UE 105 may try to connect to the network by turning on or moving into an area covered by a 5G network. UE 105 first establishes a radio connection over access network 110, specifically with the nearest gNodeB (gNB). Once the initial radio connection is established, UE 105 undergoes a registration process with core network 205. This process is managed by the AMF (i.e., AMF/SMF 120) within core network 205. UE 105 sends a registration request, which includes its identity and other relevant information, to the AMF via the gNB. The AMF coordinates with other core network functions such as the AUSF (not shown) and the UDR to authenticate UE 105. The AMF uses SCP/DRA 125 to route its request to the UDR. SCP/DRA 125 talks to SLF 220, which identifies the correct UDR segment that is hosting the subscription information for UE 105 by checking identity database 225. SLF 220 then routes the traffic through application segment 240 or application segment 250 to UDR segment 245 or UDR segment 255 based on what was indicated in identity database 225.

When the UDR segment obtains the requested authentication data for UE 105, which includes information for generating authentication vectors, this information is provided back to the AMF. Authentication vectors may then be generated, in some examples, by the AUSF and may include a random challenge (RAND), an expected response (XRES), an authentication token (AUTN), and/or other parameters used for securing the communication.

After authentication, UE 105 requests to establish a data session to access network services. This request is managed by the SMF of core network 205. The SMF sets up the session and assigns network resources, including selecting a UPF for handling UE 105's data traffic. Once connected, UE 105 can use various 5G network services such as high-speed internet, voice, video, and other data services that may be provided by the network operator and/or service provider.

Although the UDR is segmented into two segments in the example of FIG. 2, the UDR may be split up into any number of two or more segments in accordance with the technology disclosed herein, including but not limited to three, four, or five segments. The splitting of the UDR (i.e., which segment each subscription profile is hosted in) may be based on any type of business logic or other factor. In some examples, the UDR segments may be split according to subscription type (e.g., wholesale, pre-paid, retail, etc.). In such an example, some subscription types will be hosted on UDR segment 245, while other subscription types are hosted on UDR segment 255. In this way, if one service is experiencing issues, other services will not be affected.

Alternatively, provisioning call flows (northbound) initiated in CRM client 140 utilize provisioning orchestrator 230 as well as identity database 225 in accordance with the example of FIG. 2. As previously described, CRM client 140 is responsible for handling new customer onboarding, creating and loading profiles, subscription changes, and generally managing customer data. Thus, when a customer requests to add a new service or modify an existing subscription, the subscription information may be updated in CRM client 140. Changes made in CRM client 140 are then passed to provisioning orchestrator 230, a centralized provisioning system that interfaces with CRM client 140 and executes subscriber provisioning flows across the UDR database segments. Provisioning orchestrator 230 may read from or write to identity database 225 depending on task type. For example, if an existing customer requests a subscription change that does not affect which UDR segment that customer's data is stored in, provisioning orchestrator 230 checks which UDR segment that customer's data is stored in, and then accesses that segment to affect the changes. Alternatively, if a new customer is added to the network, provisioning orchestrator 230 may add the profile to the appropriate UDR segment and then write data into identity database 225 indicating where the new profile is stored.

Communication network 200 further includes migration function 260. Migration function 260 is responsible for the initial migration of subscriber profiles from the original UDR to a new UDR segment. For example, if, prior to dividing the UDR into multiple segments, UDR segment 245 is the only UDR segment and hosts subscription data for all subscriptions on the network, migration function 260 performs the migration of subscriber profiles from UDR segment 245 to UDR segment 255 over time under live traffic conditions. As the migration is performed under the live traffic conditions, identity database 225 is continually updated to reflect where the data for each subscription is hosted as migration function 260 progresses through the job. Once all applicable subscriptions hosted in UDR segment 245 are migrated to UDR segment 255, migration function 260 is no longer in use, and provisioning orchestrator 230 is responsible for making any subsequent updates to identity database 225 and the UDRs.

Core network 205, CRM client 140, and provisioning orchestrator 230 may communicate over various links that use metallic links, glass fibers, radio channels, or some other communication media. The links use Fifth Generation Core (5GC), Evolved Packet Core (EPC), IEEE 802.3 (ENET), Time Division Multiplex (TDM), Data Over Cable System Interface Specification (DOCSIS), Internet Protocol (IP), General Packet Radio Service Transfer Protocol (GTP), 5GNR, LTE, WIFI, virtual switching, inter-processor communication, bus interfaces, and/or other data communication protocols. Core network 205, CRM client 140, and provisioning orchestrator 230 may comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, Solid State Drives (SSD), Non-Volatile Memory Express (NVMe) SSDs, Hard Disk Drives (HDDs), and/or the like. The memories store software like operating systems, user applications, radio applications, network functions, and multimedia functions. The microprocessors retrieve the software from the memories and execute the software to drive the operation of communication network 200 as described herein.

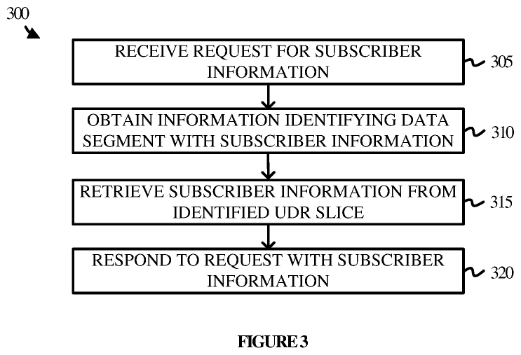

FIG. 3 illustrates process 300. Process 300 comprises an exemplary operation of an access call flow in communication network 200. The operation may vary in other examples. The operations of process 300, in some examples, are performed by SLF 220 of core network 205. The operations include receiving a request for subscriber information (step 305). The requested subscriber information is associated with a subscriber stored in a database segment of a plurality of database segments. Each database segment of the plurality of database segments stores a different portion of subscriber profiles stored across the plurality of database segments. In some examples, SLF 220 receives the request from SCP/DRA 125. However, the request originates at UE 105 and is sent to the AMF of AMF/SMF 120 via a gNB of access network 110. The request, in some examples, includes the identity of UE 105 and other relevant information. The request is then sent to SLF 220 from AMF/SMF 120 via SCP/DRA 125.

The operations of process 300 further include, in response to receiving the request, obtaining information from the identity database indicating that the subscriber information associated with the subscriber is stored in an identified database segment of the two or more database segments (step 310). In the example of FIG. 2, SLF 220, in response to receiving the request via SCP/DRA 125, obtains information from identity database 225 indicating that the subscriber information associated with UE 105 is stored in UDR segment 245.

The operations of process 300 further include, upon obtaining the information indicating that the subscriber information associated with the subscriber is stored in the identified database segment, retrieving the subscriber information associated with the identified database segment (step 315). In the example of FIG. 2, SLF 220, upon obtaining the information indicating that the subscriber information for UE 105 is stored in UDR segment 245, retrieves the subscriber information for UE 105 from UDR segment 245 through application segment 240.

The operations of process 300 further include responding to the request with the subscriber information associated with the subscriber (step 320). In the example of FIG. 2, SLF 220 responds to AMF/SMF 120 with the subscriber information from UDR segment 245. SLF 220 may, in some examples, communicate the subscriber information back to AMF/SMF 120 via SCP/DRA 125. After authentication by the AMF and/or AUSF, UE 105 may establish a data session to access services of core network 205.

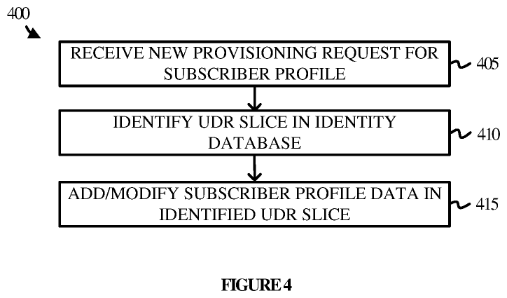

FIG. 4 illustrates process 400. Process 400 is an exemplary operation of a provisioning call flow in communication network 200. The operation may vary in other examples. The operations of process 400, in some examples, are performed by provisioning orchestrator 230 of core network 205. The operations include receiving a new provisioning request for a subscriber profile (step 405). In the example of FIG. 2, provisioning orchestrator 230 receives the new provisioning request from CRM client 140. The operations of process 400 further include, in response to receiving the new provisioning request, identifying which UDR slice is associated with the subscriber profile via a lookup in the identity database (step 410). In the example of FIG. 2, provisioning orchestrator 230, in response to the request from CRM client 140, looks up which of UDR segment 245 or UDR segment 255 hosts or is supposed to host the subscriber profile in identity database 225.

The operations of process 400 further include adding or modifying the subscriber profile data to/in the identified UDR slice (step 415). In the example of FIG. 2, provisioning orchestrator 230, after looking up the appropriate UDR segment, modifies the subscriber profile data stored in the identified UDR segment via the segment's provisioning gateway. Alternatively, provisioning orchestrator 230 may add a new subscriber profile to the identified UDR segment. In some examples, provisioning orchestrator 230 does not reference identity database 225 before adding a new subscriber profile. Instead, provisioning orchestrator 230 may already know which UDR segment to add the new profile to, add the new profile to the correct segment, and then write to identity database 225 indicating which UDR segment the new subscriber profile is in.

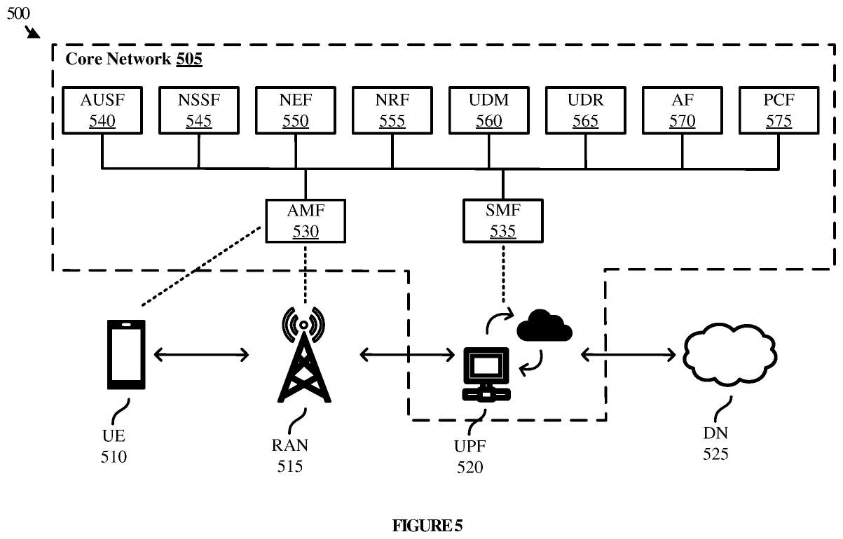

FIG. 5 illustrates 5G communication network 500. 5G communication network 500 is representative of a 5G communication network as disclosed herein having multiple UDR segments. 5G communication network 500 may be representative of communication network 200 illustrated in FIG. 2, in some examples. 5G communication network 500 includes core network 505, user equipment (UE) 510, radio access network (RAN) 515, user plane function (UPF) 520, and data network (DN) 525. Core network 505 includes AMF 530, SMF 535, Authentication Server Function (AUSF) 540, Network Slice Selection Function (NSSF) 545, Network Exposure Function (NEF) 550, Network Repository Function (NRF) 555, Unified Data Managements (UDM) 560, Unified Data Repository (UDR) 565, Application Function (AF) 570, and Policy Control Function (PCF) 575. In other examples, communication network 500 may include different or additional elements than those illustrated in FIG. 5 including but not limited to a session communication proxy (SCP), a migration function, a provisioning orchestrator, a CRM client, and the like.

UE 510, in some examples, is representative of UE 105 from the preceding Figures. RAN 515, in some examples, is representative of access network 110 from the preceding Figures. Core network 505, in some examples, is representative of core network 115 and/or core network 205 from the preceding Figures. AMF 530 and SMF 535, in some examples, are representative of AMF/SMF 120 from the preceding Figures. UDR 565, in some examples, is representative of any one of UDR 135, UDR segment 245, and/or UDR segment 255. In some cases, UDR 565 is split into multiple segments such as UDR segment 245 and UDR segment 255 in the preceding Figures. UPF 520, in some examples, is representative of UPF 215 from the preceding Figures.

AMF 530 is responsible for access and mobility management including the initial registration of devices, authentication, tracking area management, and ensuring that users remain connected as they move through the network. AMF 530 serves as the point of contact for a user device (e.g., UE 510) when it tries to connect to the 5G network (e.g., communication network 500). AMF 530 manages the establishment, maintenance, and termination of the connection between UE 510 and core network 505. SMF 535 is responsible for session management including establishing, modifying, and releasing sessions (which comprise of one or more data flows). SMF 535 also selects and manages the user plane functions, handles aspects of IP address allocation, and maintains the rules for how data should be routed and reported. SMF 535 ensures that data can be successfully transmitted between UE 510 and the internet or other network services.

AUSF 540 is also responsible for aspects of user authentication. AUSF, in part, generates and validates authentication vectors to ensure that the requesting UE is a legitimate subscriber of communication network 500. Upon successful authentication, AUSF 540 contributes to establishing a secure communication channel between UE 510 and core network 505 by facilitating the generation and distribution of security keys. AUSF 540 may also support network slicing by authenticating access to different network slices based on user subscription. AUSF 540 also supports roaming by interacting with corresponding authentication functions in other networks.

NSSF 545 is responsible for selecting the appropriate network slice for UE 510 based on UE 510′s subscription data and requested service. This may involve determining which slice or slices are best suited to meet the specific service requirements and UE 510's subscription profile. NSSF 545 is also responsible for enforcing policies related to network slice access, managing information about the network slices, and interacting with other core network functions to ensure that UE 510 is connected to the correct slice and that slice-specific rules are applied.

NEF 550 plays a role in securely exposing the capabilities of core network 505 to external applications and services. NEF 550 may perform functions such as providing standardized APIs for third-party services to access specific network capabilities or information and ensuring that the exposure of network capabilities and user data is managed securely and user privacy is maintained. NRF 555 acts as a central registry and discovery service for the network functions within core network 505. NRF 555 allows other network functions to register their services and discover the services provided by other network functions, maintains up-to-date information on the services offered by different network functions, supports load balancing and fault tolerance mechanisms within the network, and supports the scalability of the network.

UDM 560 is a central entity for managing subscriber data and authentication information. UDM 560 stores and manages subscription-specific information and is responsible for handling the authentication and authorization of users trying to access the network. Although not directly managing sessions, UDM 560 provides necessary information to other network functions, such as AMF 530 and SMF 535, to assist in session establishment and management based on the subscriber's data. UDM 560 also supports seamless service continuity and roaming by managing user identities and security information across different types of networks.

UDR 565 acts as a database (or multiple databases in the case of FIG. 2) for storing and managing structured subscriber data and service information. UDR 565 manages access to subscription data for other network functions such as AMF 530, SMF 535, and UDM 560. AF 570 is representative of external applications and services that may need to interact with core network 505 for various purposes. PCF 575 is responsible for policy management, which involves creating and enforcing policy rules for network behavior and user data transmission.

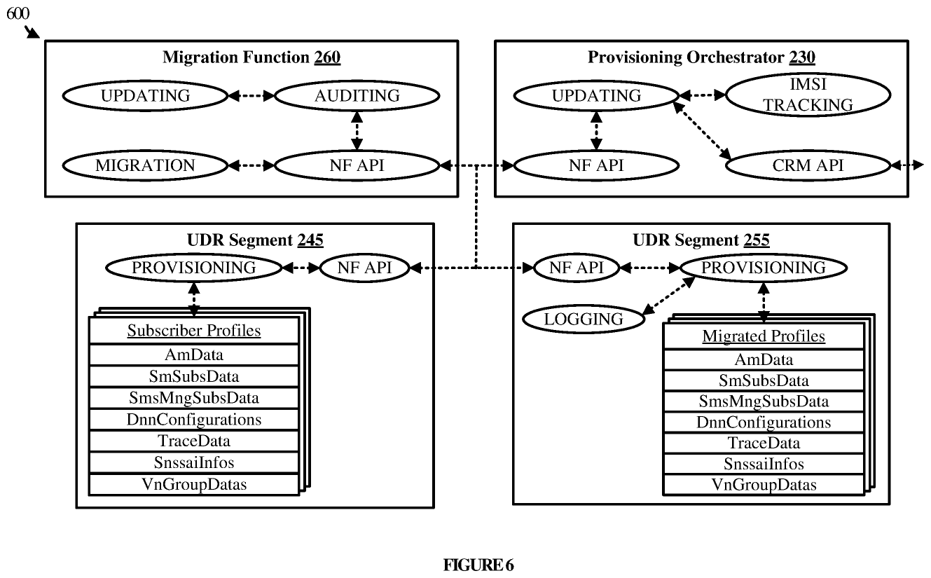

FIG. 6 illustrates wireless communication network 600. Wireless communication network 600 includes migration function 260, provisioning orchestrator 230, UDR segment 245, and UDR segment 255. Migration function 260 includes modules for UDR auditing, subscriber profile updating, subscriber profile migration, and a network function (NF) application programming interface (API). The subscriber profile migration module migrates profiles from an original UDR (e.g., UDR segment 245 or UDR 135) to a newly instantiated segment of the UDR (e.g., UDR segment 255) based on IMSI range. The migration module reads the subscription data in profiles that fall within the IMSI range stored on the original UDR and writes the data to the new UDR segment to form the migrated subscriber profiles. The migration module directs the provisioning module in UDR segment 245 to convert the migrated subscriber profiles into alias profiles.

The UDR auditing module audits UDR segment 245 to identify alias profiles that correspond to migrated profiles now hosted on UDR segment 255 in response to synchronization triggers received from the provisioning module of UDR segment 255. The subscriber profile updating module generates delta updates for the alias profiles based on logged changes to the migrated profiles. The updating module of migration function 260 transfers the delta updates to the provisioning module in UDR segment 245 to update the alias profiles and maintain the synchronization between UDR segment 245 and UDR segment 255.

UDR segment 245 includes modules for provisioning control and network function API and stores subscriber profiles and alias profiles. The provisioning control module converts active subscriber profiles into alias profiles in response to direction from the migration module in migration function 260 and implements delta updates on the alias profiles in response to direction from the updating module in migration function 260. The subscriber profile includes service attributes like access and mobility data (AmData), session management subscription data (SmSubsData), SMS management subscription data (SmsMngSubsData), DNN configurations (DnnConfigurations), Trace Data (TraceData), S-NSSAI information (snssaiInfos), and virtual network group data (VnGroupDatas).

Each subscriber profile corresponds to an IMSI of a user device. The service attributes define the level of service for a user device and often differ from profile to profile. It should be appreciated that these service attributes are exemplary and may differ in other examples. The alias profiles also include the service attributes and correspond to the migrated profiles stored on UDR segment 255. The alias profiles represent inactive clones of the migrated subscriber profiles to maintain subscription data synchronization between UDR segment 245 and UDR segment 255. For example, one of the alias profiles stored on UDR segment 245 and the corresponding migrated subscriber stored on UDR segment 255 would store the same service attributes.

UDR segment 255 includes modules for provisioning control, change logging, and network function API, as well as stores migrated subscriber profiles. The provisioning control module in UDR segment 255 implements updates to migrated subscriber profiles and creates new subscriber profiles based on directions from provisioning orchestrator 230. The change logging module tracks changes made to the migrated subscriber profiles. The provisioning control module notifies migration function 260 to trigger UDR synchronization and pushes the logged changes towards migration function 260. The migrated subscriber profiles include service attributes such as AmData, SmSubsData, SmsMngSubsData, DnnConfigurations, TraceData, SnssaiInfos, and VnGroupDatas. Corresponding ones of the migrated subscriber profiles stored by UDR segment 255 and the alias profiles stored by UDR segment 245 are both associated with the same IMSI.

Provisioning orchestrator 230 includes modules for subscriber profile updating, IMSI tracking, a network function API, and a CRM client API. The subscriber profile updating module processes updates received from CRM client 140. The updates may modify subscriber profiles on UDR segment 245 and UDR segment 255 or create new subscriber profiles on UDR segment 245 and UDR segment 255. The IMSI tracking module tracks the distribution of subscriber profiles on UDR segment 245 and UDR segment 255. For example, the IMSI tracking module may identify a first IMSI range that corresponds to UDR segment 245 and a second IMSI range that corresponds to UDR segment 255. The updating module in provisioning orchestrator 230 interfaces with the IMSI tracking module to determine where to push updates received from CRM client 140. The interfacing modules allow migration function 260, UDR segment 245, UDR segment 255, and provisioning orchestrator 230 to exchange signaling with each other, the other network functions/entities in core network 205 and external systems like CRM client 140.

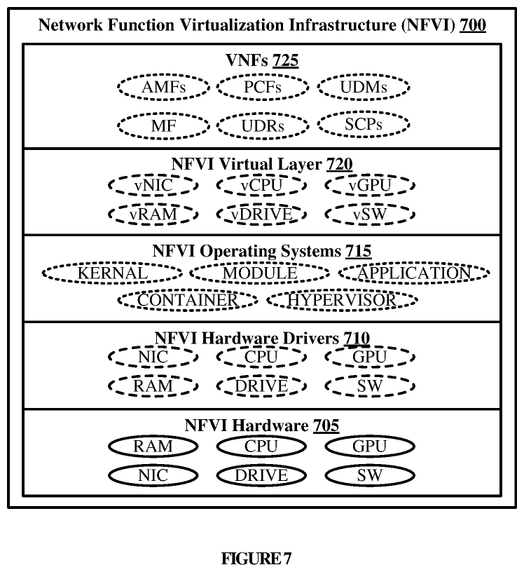

FIG. 7 illustrates Network Function Virtualization Infrastructure (NFVI) 700 in a 5G wireless communication network. NFVI 700 represents an example of core network 115, core network 205, and/or core network 505 from the preceding Figures, although these core networks may differ in architecture and implementation. NFVI 700 comprises NFVI hardware 705, NFVI hardware drivers 710, NFVI operating systems 715, NFVI virtual layer 720, and NFVI Virtual Network Functions (VNFs) 725. NFVI hardware 705 includes but is not limited to Network Interface Cards (NICs), CPU, GPU, RAM, Flash/Disk Drives (DRIVE), and Data Switches (SW). NFVI hardware drivers 710 includes but is not limited to software that is resident in the NIC, CPU, GPU, RAM, DRIVE, and SW. NFVI operating systems 715 includes but is not limited to kernels, modules, applications, containers, hypervisors, and the like. NFVI virtual layer 720 includes but is not limited to vNIC, vCPU, vGPU, vRAM, vDRIVE, and vSW. NFVI VNFs 725 includes but is not limited to AMFs, PCFs, UDMs, SCPs, MF, and UDRs. Additional VNFs and network elements like SMF, UPF, AUSF, NSSF, NRF, EIR, NEF, and AF may also be present but are omitted from FIG. 7 for the sake of clarity.

NFVI 700, in some embodiments, refers to the physical and virtual resources that support the deployment, operation, and management of virtual network functions within core network 115, core network 205, and/or core network 505. NFVI 700 includes the physical servers, storage, and network switches that provide the basic computational, storage, and networking capabilities. These resources, in some examples, are located in data centers and may be distributed or centralized. NFVI virtual layer 720 includes software that abstracts the hardware resources and allows them to be shared among different VNFs. This may involve the leveraging of one or more hypervisors or container management systems that create and manage virtual machines or containers.

NFVI 700 includes, generally, virtual counterparts to the physical resources (e.g., virtual CPUs, virtual memory, virtual networks) that are allocated to the VNFs. These resources can be scaled up or down as needed, providing flexibility and scalability. Although not a part of NFVI 700 per se, NFVI 700 may be closely integrated with management and orchestration (MANO) frameworks that handle the deployment, connection, scaling, and management of virtual network functions on NFVI 700. This may include functions such as virtual network function manager (VNFM), virtualized infrastructure manager (VIM), and network function virtualization orchestrator (NFVO).

NFVI 700, in the context of a 5G network, enables the deployment of network services as software instances, making the network more adaptable and efficient. NFVI 700 supports 5G goals of high scalability, flexibility, and resource efficiency, thereby enabling rapid deployment and dynamic scaling of network services to meet changing demands. The virtualized nature of NFVI 700 aligns with the 5G goals of achieving a software-defined network architecture, which can support a wide range of services from high-speed internet to large IoT deployments.

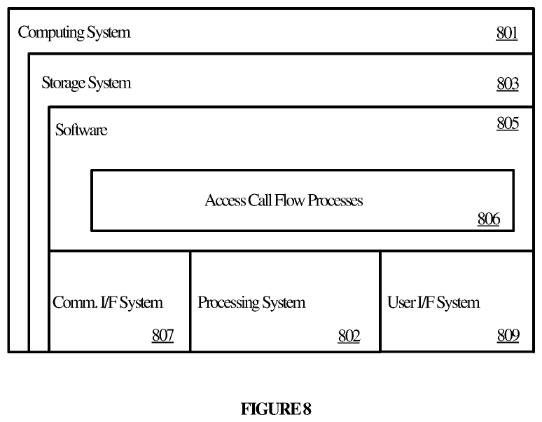

FIG. 8 illustrates computing system 801, which is representative of any system or collection of systems in which the various processes, programs, services, and scenarios disclosed herein may be implemented. Examples of computing system 801 include, but are not limited to, server computers, web servers, cloud computing platforms, and data center equipment, as well as any other type of physical or virtual server machine, container, and any variation or combination thereof. Examples also include desktop and laptop computers, tablet computers, mobile computers, and wearable devices.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements access call flow processes 806, which is representative of the access call flow processes discussed with respect to the preceding Figures, such as process 300. Software 805 may also include and implement provisioning call flow processes, which is representative of the provisioning call flow processes discussed with respect to the preceding Figures, such as process 400. When executed by processing system 802, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including access call flow processes 806) may be implemented in program instructions and among other functions may, when executed by processing system 802, direct processing system 802 to operate as described with respect to the various operational scenarios, sequences, and processes illustrated herein. For example, software 805 may include program instructions for implementing the access call flow or provisioning call flow processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to perform the 5G network processes described herein. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary, etc.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The wireless data network circuitry described above comprises computer hardware and software that form special-purpose wireless system circuitry to serve wireless user devices based on policies. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose wireless system circuitry to serve wireless user devices based on policies.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents. The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of operating a wireless communication network, the method comprising:
receiving a request for subscriber information associated with a subscriber stored in a database segment of a plurality of database segments, wherein each database segment of the plurality of database segments stores a different portion of subscriber profiles stored across the plurality of database segments;
in response to the request, obtaining information indicating that the subscriber information associated with the subscriber is stored in the database segment;
upon obtaining the information indicating that the subscriber information associated with the subscriber is stored in the database segment, retrieving the subscriber information associated with the subscriber from the database segment; and
responding to the request with the subscriber information associated with the subscriber.

2. The method of claim 1 wherein the plurality of database segments make up a unified database repository (UDR) associated with the wireless communication network.

3. The method of claim 1 wherein the request is from an authentication entity of the wireless communication network and wherein the authentication entity sent the request for the subscriber information associated with the subscriber in response to receiving an authentication request associated with the subscriber.

4. The method of claim 1 wherein responding to the request with the subscriber information associated with the subscriber comprises responding to the request with one or more authentication vectors generated based on the subscriber information associated with the subscriber stored in the database segment.

5. The method of claim 1 wherein the request is part of an authentication call flow to verify that the subscriber is authorized to access one or more services of the wireless communication network.

6. The method of claim 1 wherein the request is part of a session establishment call flow to establish a new session for the subscriber for accessing one or more services of the wireless communication network.

7. The method of claim 1 wherein the subscriber information includes at least one of a quality of service parameter, a service entitlement, subscriber identity data, subscriber location information, or service plan details.

8. The method of claim 1 wherein the wireless communication network is a Fifth Generation (5G) cellular communication network.

9. A wireless communication network comprising:
a unified data repository (UDR) comprising two or more database segments, wherein each database segment of the two or more database segments stores a different portion of subscriber profiles in the UDR;
an identity database configured to store information indicating which database segment of the two or more database segments stores subscriber information for each subscriber profile of the subscriber profiles in the UDR; and
a subscriber location function component configured to:
receive a request for subscriber information associated with a subscriber stored in a database segment of the two or more database segments;
in response to the request, obtain information from the identity database indicating that the subscriber information associated with the subscriber is stored in an identified database segment of the two or more database segments;
upon obtaining the information indicating that the subscriber information associated with the subscriber is stored in the identified database segment, retrieve the subscriber information associated with the identified database segment; and
respond to the request with the subscriber information associated with the subscriber.

10. The wireless communication network of claim 9 further comprising a provisioning orchestrator configured to load the subscriber information for the subscriber profiles into the two or more database segments.

11. The wireless communication network of claim 10 wherein the provisioning orchestrator is further configured to, before loading subscriber information for a subscriber to a database segment of the two or more database segments, look up which database segment of the two or more database segments the subscriber is assigned to in the identity database.

12. The wireless communication network of claim 9 further comprising an authentication component configured to send the request for the subscriber information associated with the subscriber in response to receiving an authentication request associated with the subscriber.

13. The wireless communication network of claim 9 wherein the subscriber location function, to respond to the request with the subscriber information associated with the subscriber, responds to the request with one or more authentication vectors generated based on the subscriber information associated with the subscriber stored in the identified database segment.

14. The wireless communication network of claim 9 wherein the subscriber information associated with the subscriber comprises at least one of a quality of service parameter, a service entitlement, subscriber identity data, subscriber location information, or service plan details.

15. The wireless communication network of claim 9 wherein the wireless communication network is a Fifth Generation (5G) cellular communication network.

16. One or more non-transitory computer-readable storage media having program instructions stored thereon, wherein the program instructions, when executed by a computing system, direct the computing system to perform operations, the operations comprising:
receiving a request for subscriber information associated with a subscriber stored in a database segment of a plurality of database segments, wherein each database segment of the plurality of database segments stores a different portion of subscriber profiles stored across the plurality of database segments;
in response to the request, obtaining information indicating that the subscriber information associated with the subscriber is stored in the database segment;
upon obtaining the information indicating that the subscriber information associated with the subscriber is stored in the database segment, retrieving the subscriber information associated with the subscriber from the database segment; and
responding to the request with the subscriber information associated with the subscriber.

17. The non-transitory computer-readable storage media of claim 16 wherein the plurality of database segments make up a unified database repository (UDR) associated with the wireless communication network.

18. The non-transitory computer-readable storage media of claim 16 wherein the request is from an authentication entity of the wireless communication network and wherein the authentication entity sent the request for the subscriber information associated with the subscriber in response to receiving an authentication request associated with the subscriber.

19. The non-transitory computer-readable storage media of claim 16 wherein responding to the request with the subscriber information associated with the subscriber comprises responding to the request with one or more authentication vectors generated based on the subscriber information associated with the subscriber stored in the database segment.

20. The non-transitory computer-readable storage media of claim 16 wherein the wireless communication network is a Fifth Generation (5G) cellular communication network.
